(19) United States
(12) Patent Application Publication
(10) Pub. No.: US 2014/0297551 A1
(43) Pub. Date: Oct. 2, 2014

(54) System and Method of Evaluating a Candidate Fit for a Hiring Decision

(71) Applicant: HireIQ Solutions, Inc., Alpharetta, GA (US)

(72) Inventor: Todd Merrill, Alpharetta, GA (US)

(73) Assignee: HIREIQ SOLUTIONS, INC., Alpharetta, GA (US)

(21) Appl. No.: 14/243,331

(22) Filed: Apr. 2, 2014

Related U.S. Application Data
(60) Provisional application No. 61/807,488, filed on Apr. 2, 2013.

(51) Int. Cl. G06Q 10/10

(52) U.S. Cl. CPC G06Q 10/1053
USPC 705/321

(57) ABSTRACT

The Applicants have developed a system and methods for extracting timing and emotional content from recorded audio in order to automate screening decisions for hiring candidates by processing candidate audio responses to predict candidate alignment for given job position. Emotional content is extracted using variable models to optimize detection of specific emotional content of interest. A feedback system is implemented for job supervisors to rate employee performance. Jobs are categorized according to emotional requirements and feedback is used to optimize candidate emotional alignment for a given position.

### CROSS-REFERENCE TO RELATED APPLICATIONS

This application claims priority to U.S. Provisional Application No. 61/807,488, filed Apr. 2, 2013, the content of which is incorporated herein by reference in its entirety.

### FIELD

The present application relates to the field of evaluating a candidate for a hiring decision. More specifically, the present application relates to the field of candidate evaluation based on extraction of emotional features.

### BACKGROUND

In the field of candidate evaluation, recruiters are often used to evaluate candidates and place candidates with employers. However, companies suspect that recruiters are not hiring the right people, as turnover is very high in some organizations such as call center operations. A new method is needed to select candidates that are better aligned with job function so as to minimize attrition.

### SUMMARY

The Applicants have developed a system and method for extracting timing and emotional content from recorded audio in order to automate screening decisions for hiring candidates by processing candidate audio responses to predict candidate alignment for given job position. Emotional content is extracted using variable models to optimize detection of specific emotional content of interest. A feedback system is implemented for job supervisors to rate employee performance. Jobs are categorized according to emotional requirements and feedback is used to optimize candidate emotional alignment for a given position.

In one aspect of the present application, a computerized method of evaluating a plurality of candidates from an audio response collected from the plurality of candidates includes extracting a set of raw emotional features from the audio responses of each of the plurality of candidates; isolating a set of relevant emotional features, an energy level and a valence level from an audio clip of the plurality of raw emotional features; categorizing a plurality of jobs according to a set of emotional requirements; and plotting the set of relevant emotional features, the energy level and the valence level over the categorized plurality of jobs.

In another aspect of the present invention, a computer readable medium having computer executable instructions for performing a method of evaluating a plurality of candidates from a plurality of audio responses, includes extracting a set of raw emotional features from the audio responses of each of the plurality of candidates; isolating a set of relevant emotional features, an energy level and a valence level from an audio clip of the plurality of raw emotional features; categorizing a plurality of jobs according to a set of emotional requirements; and plotting the set of relevant emotional features, the energy level and the valence level over the categorized plurality of jobs.

In yet another aspect of the present application, a system for evaluating a plurality of candidates from a plurality of audio responses includes a storage system; and a processor programmed to extract and isolate a set of relevant emotional features, an energy level and a valence level from an audio clip of a plurality of raw emotional features; and plotting the set of relevant emotional features, the energy level and the valence level over a categorized plurality of jobs.

### BRIEF DESCRIPTION OF THE DRAWINGS

FIG. 1 is a schematic diagram illustrating an embodiment of the system of the present application.

FIG. 2 is a graphical representation of an embodiment of an affective circumplex of the present application.

FIG. 3 is a graphical representation of an embodiment of an affective circumplex of the present application.

FIG. 4 is a graphical user interface of an embodiment of the present application.

FIG. 5 is a graphical representation of an embodiment of an affective circumplex of the present application.

FIG. 6 is a flow chart illustrating an embodiment of a method of the present application

FIG. 7 is a system diagram of an exemplary embodiment of a system of the present application.

### DETAILED DESCRIPTION OF THE DRAWINGS

In the present description, certain terms have been used for brevity, clearness and understanding. No unnecessary limitations are to he applied therefrom beyond the requirement of the prior art because such terms are used for descriptive purposes only and are intended to be broadly construed. The different systems and methods described herein may be used alone or in combination with other systems and methods. Various equivalents, alternatives and modifications are possible within the scope of the appended claims. Each limitation in the appended claims is intended to invoke interpretation under 35 U.S.C. §112, sixth paragraph, only if the terms “means for” or “step for” are explicitly recited in the respective limitation.

The system and method of the present application may be effectuated and utilized with any of a variety of computers or other communicative devices, exemplarily, but not limited to, desk top computers, laptop computers, tablet computers, or smart phones. The system will also include, and the method will be effectuated by a central processing unit that executes computer readable code such as to function in the manner as disclosed herein. Exemplarily, a graphical display that visually presents data as disclosed herein by the presentation of one or more graphical user interfaces (GUI) is present in the system. The system further exemplarily includes a user input device, such as, but not limited to, a keyboard, mouse, or touch screen that facilitate the entry of data as disclosed herein by a user. Operation of any part of the system and method may be effectuated across a network or over a dedicated communication service, such as land line, wireless telecommunications, or LAN/WAN.

The system further includes a server that provides accessible web pages by permitting access to computer readable code stored on a non-transient computer readable medium associated with the server, and the system executes the computer readable code to present the GUIs of the web pages.

Embodiments of the system can further have communicative access to one or more of a variety of computer readable mediums for data storage. The access and use of data found in these computer readable media are used in carrying out embodiments of the method as disclosed herein.

Disclosed herein are various embodiments of methods and systems related to processing candidate audio responses to predict candidate alignment for a given job position. Emotional content is extracted using varying models to optimize detection of specific emotional content of interest. A feedback system is implemented for job supervisors to rate employee performance. Jobs are categorized according to emotional requirements and feedback is used to optimize candidate emotional alignment for a given position.

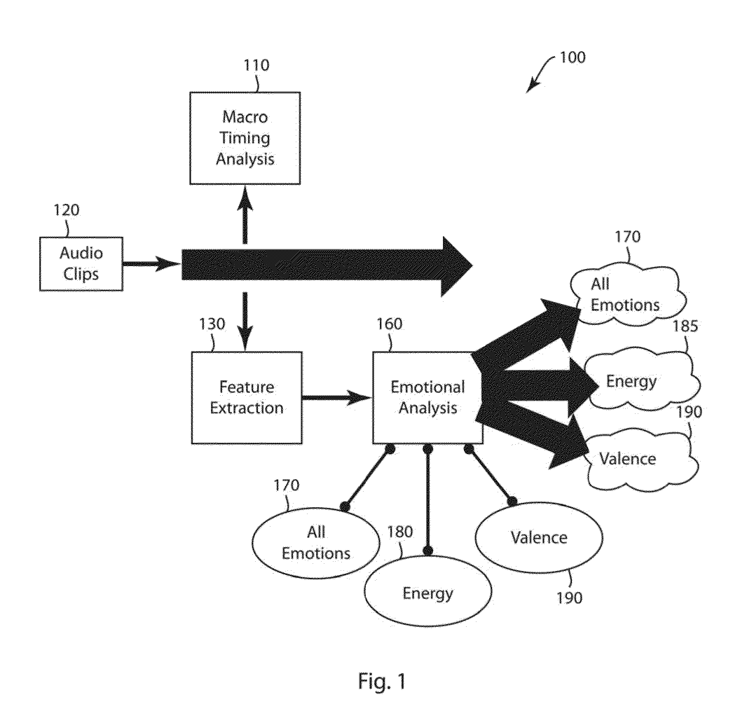

FIG. 1 illustrates the relationships of major components of the system in the exemplar embodiment.

In further embodiments audio signals may be extracted from additional audio sources including, but not limited to video interview sessions. In a Macro Timing Analysis Module 110 of the system 100, gross analysis of the audio clips 120 occurs before in-depth analysis occurs. Each gross attribute is recorded for the individual audio clip 120, and is incorporated into statistics for the general population of candidate responses to that question.

Still referring to FIG. 1, the system also includes extraction, of detailed audio signal features with a feature extraction module 130. These audio features are used in a subsequent emotional analysis 160 in order to recognize emotional content of the audio clip 120. In one embodiment, the system 100 of the present application utilizes a feature extraction module 130 that includes a number of audio features. In one embodiment, the feature extraction module 130 utilizes a general audio signal processing, utilizing windowing functions such as Hamming, Hann, Gauss and Sine, as well as fast-fourier transform processing. The main feature extraction module 130 may also utilize a pre-emphasis filter, autocorrelation and cepstrum for general audio signal processing. The feature extraction module 130 is configured to extract speech related features such as signal energy, loudness, mel-spectra, MFCC, pitch and voice quality. The feature extraction module 130 also is configured to move average smoothing of feature contours, moving average mean subtraction, for example, for online ceptral mean subtraction and delta regression coefficients of arbitrary order. The feature extraction module 130 is also configured to extract means, extreme, moments, segments, peaks, linear and quadratic regression, percentiles, durations, onsets and DCT coefficients. While the foregoing features and functionality of the feature extraction module 130 is set forth above for an embodiment of the present application, it should be noted that other feature extraction modules and applications may be utilized.

Still referring to FIG. 1, an emotional analysis module 160 receives the output of the feature extraction module 130 in order to analyze the feature extraction module 130 output and detect emotions.

Training models may be used to train several learning algorithms to detect such emotional content. In one embodiment, the Berlin Database of Emotional Speech (Emo-DB) is utilized for emotional analysts 160. It should be understood that additional embodiments may include other known proprietary emotional analysis 160 databases.

Emo-DB has advantages such that the emotions are short and well classified, as well as deconstructed for easier verification. The isolated emotions are also recorded in a professional studio, are high quality, and unbiased. However, the audio in Emo-DB is from trained actors and not live sample data. A person acting angry may have different audio characteristics than someone actually angry.

In another embodiment, building a learning model based on existing candidate data may be made. Also, another approach is to compare raw emotions against large feature datasets.

Another approach, for increasing machine learning accuracy is to pre-combine different datasets. For instance, when trying to identify speaker emotion, male and female speakers are first separated and then predicted sex-specific emotion classifications are applied. These pre-combined models perform with higher accuracy than the generic models.

In the exemplar embodiment, the information generated from the emotional analysis 160 of recorded audio responses is used to express an overall Emotional Affect, or permanent emotional makeup for the candidate. This estimation of Affect is used to determine how closely a candidate's emotional nature aligns with the emotional requirements for a given position.

Still referring to FIG. 1, six fundamental emotions 170, general Energy 180 and overall Valence 190 are identified in a group of audio responses in the Emotional Analysis 160 and outputted to a Circumplex 210. Audio questions submitted to the candidate can be designed to elicit a greater response from target emotions in order to measure that component of the candidate's Emotional Affect.

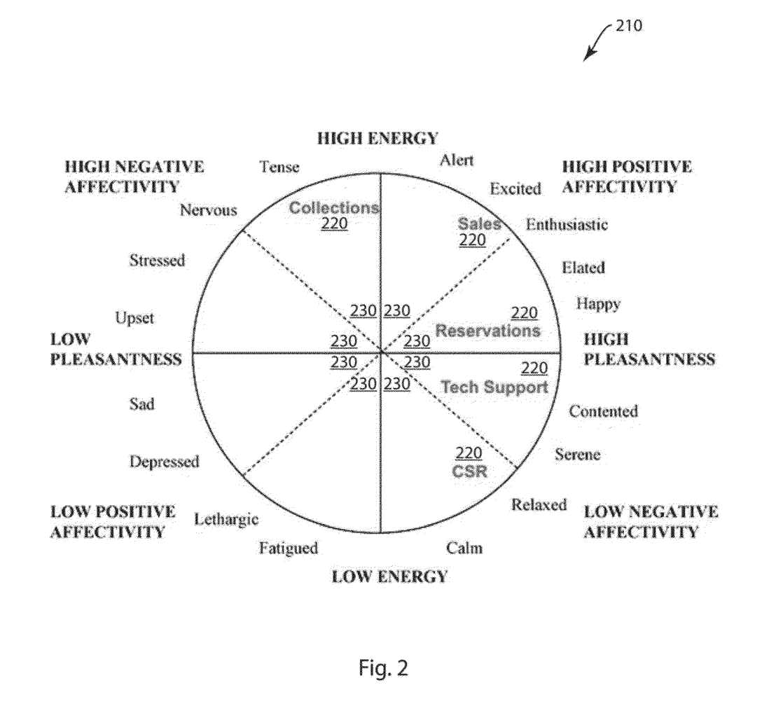

Referring now to FIG. 2, in the exemplar embodiment of a Circumplex 210, call center positions are classified into five basic groups 220 of positions based on the emotional requirements for the position, e.g. Collections, Sales, Reservations, Tech Support and CSR. Given the Affective Circumplex 210 model of Emotional Affect, each basic group 220 is mapped into a region 230 of the Circumplex 210, as illustrated in FIG. 2. It should be noted that the five basic groups 220 of positions based on the emotion requirements for the position may be modified by adding, removing or amending any of the five exemplary basic groups 220 included in FIG. 2. Those five basic groups 220 and any derivative groups 220 is then mapped into a region 230 of the Circumplex 210 accordingly.

In the exemplar embodiment, each candidate is evaluated for emotional content across each of the audio responses provided and an aggregate score of overall affect is generated. In the Circumplex 210 of FIG. 2, Valence is illustrated along the horizontal axis of the Circumplex 210, with high pleasantness Valence scores being plotted right of the center of the Circumplex 210 and low pleasantness Valence scores being plotted on the left half of the Circumplex 210. Energy 180 is illustrated along the Y-axis of the Circumplex 210 with high energy measurement being plotted in the top half of the Circumplex 210 and low energy on the bottom half of the Circumplex 210. A point is plotted inside of the Circumplex representing where that candidate exists in the emotional space defined by the Circumplex 210.

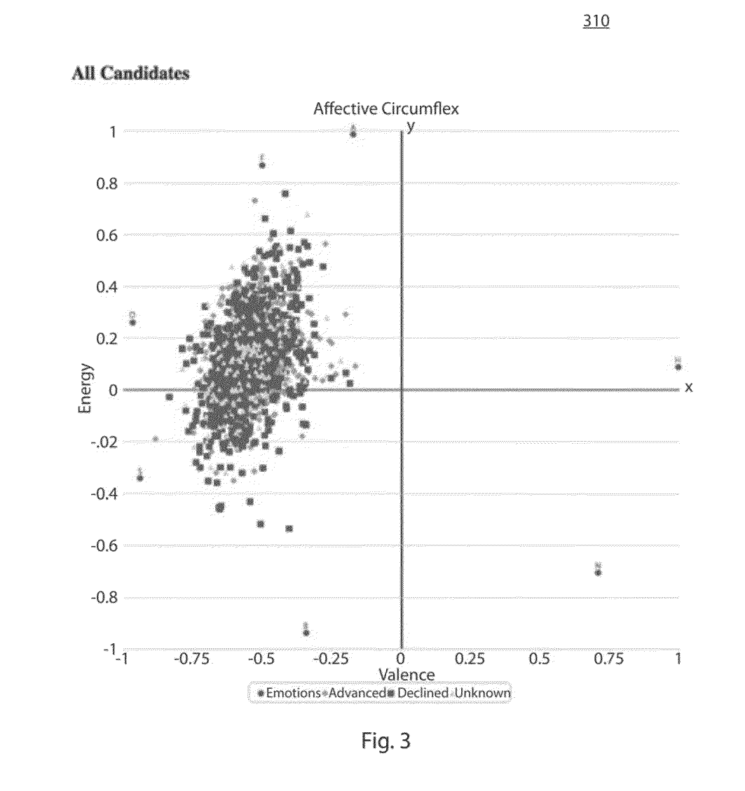

Referring now to FIG. 3, a histogram 310 of emotional content is generated for each audio response. The histograms contain up to six fundamental emotions; A(Anger), F(Fear), D(Disgust), B(Bored), S(Sad), H(Happy) with each syllable in an audio clip assigned one discrete emotion from the set. In additional embodiments, different emotion sets and time slices are anticipated.

Vectors are assigned to each of the emotions in the extracted set of emotions corresponding to where each emotion resides on the theoretical Affective Circumplex 310. Each emotional vector is scaled by a factor representing the frequency of occurrence of the given emotion in the total population of emotions for all of a candidate's responses.

Vector math is used to add the resulting six vectors and a point is plotted on an ideal Circumplex 310. FIG. 3 is a representation of ail candidates for a given position color-coded or coded by symbols or some other fashion for Advanced Candidates and for Declined candidates. Again, in the Circumplex 310 of FIG. 3, for any given position, the Valence of the plotted point is shown along the X-axis, and the energy along the Y-axis.

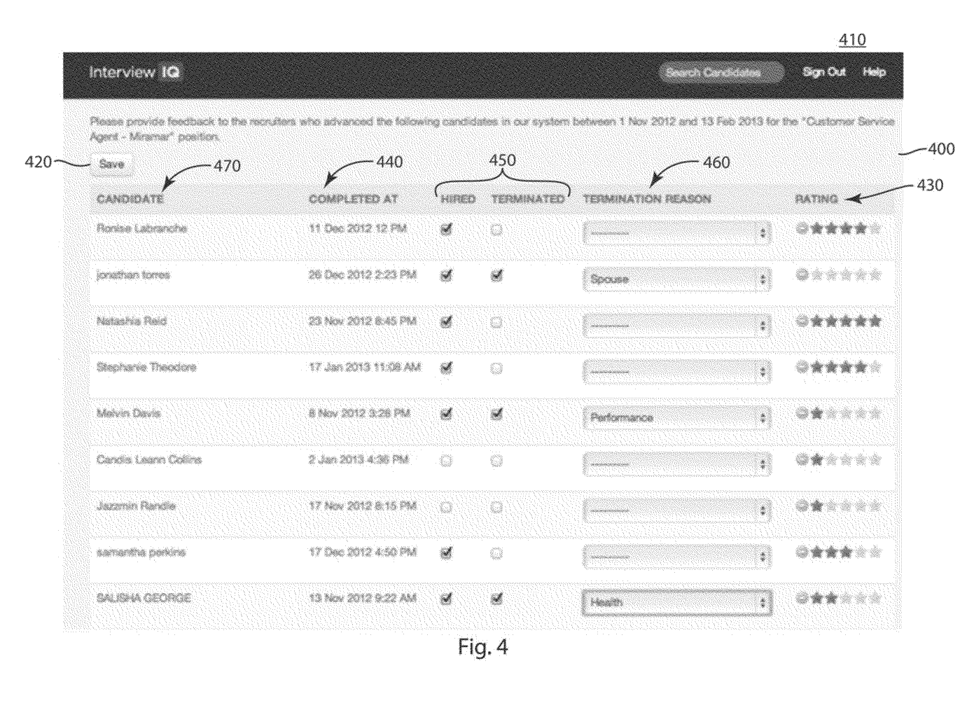

Referring now to FIG. 4, a feedback loop is established from the post-hire management for each candidate and periodic job performance feedback is provided. In FIG. 4, a screen shot of a feedback form 400 in a graphical user interface 410 is illustrated. Here, utilizing touch screen capabilities or a mouse, or some other input/output device, a user may provide feedback for any of a number of candidates in a list of candidates 420. This feedback form 400 allows a user to rate the candidates in the rating column 430 by utilizing any one of a number of known rating systems such as stars, numerical, or other known rating systems. The user may then, utilize the feedback form 400 in order to indicate the status of the candidate; in other words, whether the candidate was hired or terminated, or both in the status columns 450. If terminated, the user may provide a termination reason 460. The feedback form 400 records the time the feedback is completed 440 and the user may save feedback by engaging the save icon 470. In the exemplar embodiment, a feedback form is provided for a given date range for a given position as seen in FIG. 4. Operational feedback is matched up with Emotional Affect of candidates in order to identify ideal affect for a given position at a given company.

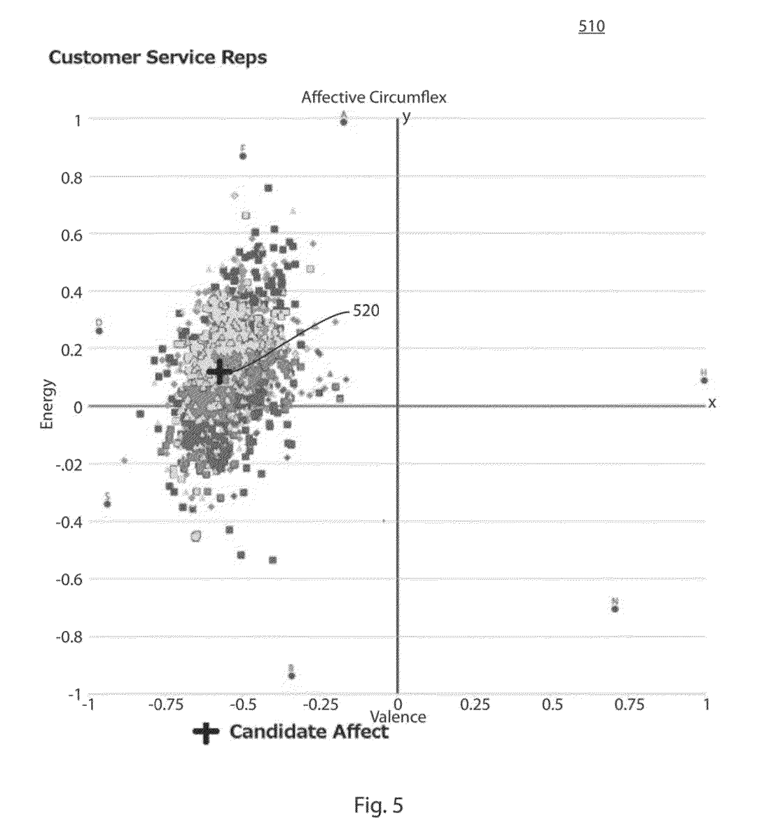

Post Hire Feedback ratings are used to identify highly positively and negatively correlated regions to success on the job. These ratings are then displayed on the Circumplex 510. In FIG. 5 a candidate 520 is shown among recently hired employees who have been rated by their operational supervisors. Feedback scores are rated from using a “heatmap” scale of, for example, blue=low, green, yellow, orange, red=high. Again, symbols or some other coding system may be utilized.

Once predictive regions on the Circumplex 510 are identified through operational feedback, candidates that are not a good emotional fit for a particular position can be identified as good fits for other positions that are available. Continuous recruitment of well-suited emotional candidates results in positive impact on Attrition.

A given candidate may be evaluated emotionally as a fit for any given position, the whole company in general and can be displayed against the universe of positions with similar emotional categories.

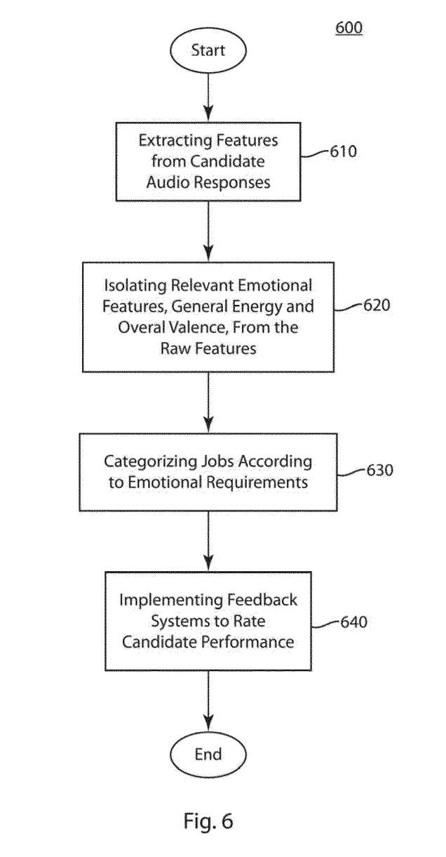

Now referring to FIG. 6 of the present application, a method 600 of the present application is illustrated. In step 610, raw emotional features are extracted from candidate audio responses. As discussed above, an audio clip of a sound recording of a candidate is processed and a macro timing analysis is carried out on the audio clip to extract pace, length, and percentage of silence within the audio clip, and feature extraction is utilized to remove and extract audio features from the audio clip. In step 620, an emotional analysis is carried out on the extracted features, and relevant features from the raw emotional analysis are derived such as general energy and overall valence. In step 630, jobs are categorized according to emotional requirements, and candidates are plotted according to their emotional analysis, and are assigned to the categorized jobs accordingly. In step 640, a feedback system is implemented to rate candidate performance and to update the categorizing of step 630.

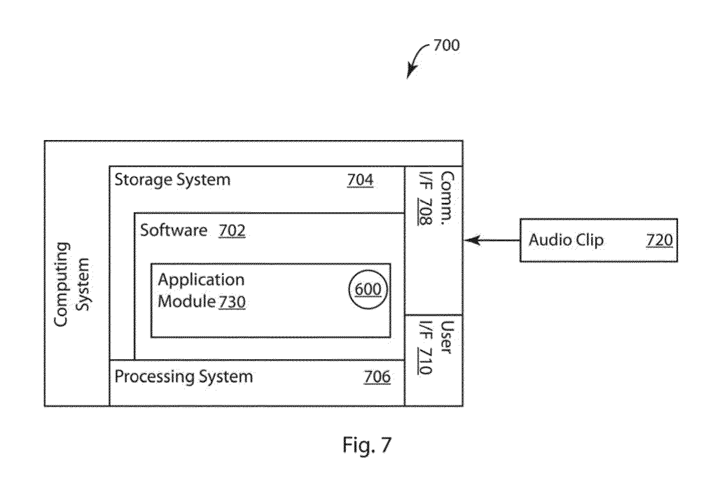

FIG. 7 is a system diagram of an exemplary embodiment of a system 700 for candidate scoring. The system 700 is generally a computing system that includes a processing system 706, storage system 704, software 702, communication interface 708 and a user interface 710. The processing system 706 loads and executes software 702 from the storage system 704, including a software module 730. When executed by the computing system 700, application module 730 directs the processing system 706 to operate as described in herein in further detail in accordance with the method 600.

Although the computing system 700 as depicted in FIG. 7 includes one application module 730 in the present example, it should be understood that one or more modules could provide the same operation. Similarly, while description as provided herein refers to a computing system 700 and a processing system 706, it is to be recognized that implementations of such systems can be performed using one or more processors, which may be communicatively connected, and such implementations are considered to be within the scope of the description.

The processing system 706 can comprise a microprocessor and other circuitry that retrieves and executes software 702 from storage system 704. Processing system 706 can be implemented within a single processing device but can also be distributed across multiple processing devices or sub-systems that cooperate in existing program instructions. Examples of processing system 706 include general purpose central processing units, applications specific processors, and logic devices, as well as any other type of processing device, combinations of processing devices, or variations thereof.

The storage system 704 can comprise any storage media readable by processing system 706, and capable of storing software 702. The storage system 704 can include volatile and non-volatile, removable and non-removable media implemented in any method or technology for storage of information, such as computer readable instructions, data structures, program modules, or other data. Storage system 704 can be implemented as a single storage device but may also be implemented across multiple storage devices or sub-systems. Storage system 704 can further include additional elements, such a controller capable, of communicating with the processing system 706.

Examples of storage media include random access memory, read only memory, magnetic discs, optical discs, flash memory, virtual memory, and non-virtual memory, magnetic sets, magnetic tape, magnetic disc storage or other magnetic storage devices, or any other medium which can be used to storage the desired information and that may be accessed by an instruction execution system, as well as any combination or variation thereof or any other type of storage medium. In some implementations, the store media can be a non-transitory storage media. In some implementations, at least a portion of the storage media may be transitory. It should be understood that in no ease is the storage media a propagated signal.

User interface 710 can include a mouse, a keyboard, a voice input device, a touch input device for receiving a gesture from a user, a motion input device for detecting non-touch gestures and other motions by a user, and other comparable input devices and associated processing elements capable of receiving user input from a user. Output devices such as a video display or graphical display can display an interface further associated with embodiments of the system and method as disclosed herein. Speakers, printers, haptic devices and other types of output devices may also be included in the user interface 710.

While embodiments presented in the disclosure refer to evaluations for candidates in the hiring process additional embodiments are possible for other domains where assessments or evaluations are given for other purposes. In the foregoing description, certain terms have been used for brevity, clearness, and understanding. No unnecessary limitations are to be inferred therefrom beyond the requirement of the prior art because such terms are used for descriptive purposes and are intended to be broadly construed. The different configurations, systems, and method steps described herein may be used alone or in combination with other configurations, systems and method steps. It is to be expected that various equivalents, alternatives and modifications are possible within the scope of the appended claims.

What is claimed is:

1. A computerized method of evaluating a plurality of candidates from an audio response collected from the plurality of candidates, comprising:
extracting a set of raw emotional features from the audio responses of each of the plurality of candidates;
isolating a set of relevant emotional features, an energy level and a valence level from an audio clip of the plurality of raw emotional features;
categorizing a plurality of jobs according to a set of emotional requirements; and
plotting the set of relevant emotional features, the energy level and the valence level over the categorized plurality of jobs.

2. The method of claim 1, further including implementing a feedback system in order to rate a performance of the plurality of candidates.

3. The method of claim 2, wherein the feedback system includes a graphical user interface to facilitate collection of a set of feedback information from a user.

4. The method of claim 1, wherein extracting the set of raw emotional features includes extracting a set of detailed audio signals from the audio clips with a feature extraction module.

5. The method of claim 4, wherein extracting the set of raw emotional features includes analyzing the set of detailed audio signals and detecting a plurality of emotions with an emotional analysis module.

6. The method of claim 5, wherein the emotional analysis module separates the plurality of emotions into the set of relevant emotional features, the energy level and the valence level.

7. The method of claim 5, wherein the emotional analysis module is a speech database.

8. The method of claim 5, wherein the emotional analysis module is a learning model, wherein the learning model is built through extracting the set of raw emotional features from a plurality of audio clips.

9. The method of claim 1, wherein the plotting of the set of relevant emotional features over the categorized plurality of jobs is effectuated on a Circumplex.

10. The method of claim 9, wherein the Circumplex includes a plurality of regions, and each of the plurality of jobs is categorized and mapped into one of the plurality of regions.

11. The method of claim 9, wherein the energy level is plotted along the Y axis of the Circumplex and the valence level is plotted along the X axis of the Circumplex.

12. A computer readable medium having computer executable instructions for performing a method of evaluating a plurality of candidates from a plurality of audio responses, comprising:
extracting a set of raw emotional features from the audio responses of each of the plurality of candidates;
isolating a set of relevant emotional features, an energy level and a valence level from an audio clip of the plurality of raw emotional features;
categorizing a plurality of jobs according to a set of emotional requirements; and
plotting the set of relevant emotional features, the energy level and the valence level over the categorized plurality of jobs.

13. The computer readable medium of claim 12, further including implementing a feedback system in order to rate a performance of the plurality of candidates.

14. The computer readable medium of claim 13, wherein the feedback system includes a graphical user interface to facilitate collection of a set of feedback information from a user.

15. The computer readable medium of claim 12, wherein extracting the set of raw emotional features includes extracting a set of detailed audio signals from the audio clips with a feature extraction module.

16. The computer readable medium of claim 15, wherein extracting the set of raw emotional features includes analyzing the set of detailed audio signals and detecting a plurality of emotions with an emotional analysis module.

17. The computer readable medium of claim 16, wherein the emotional analysis module separates the plurality of emotions into the set of relevant emotional features, the energy level and the valence level.

18. The computer readable medium of claim 16, wherein the emotional analysis module is a speech database.

19. The computer readable medium of claim 16, wherein the emotional analysis module is a learning model, wherein the learning model is built through extracting the set of raw emotional features from a plurality of audio clips.

20. The computer readable medium of claim 12, wherein the plotting of the set of relevant emotional features over the categorized plurality of jobs is effectuated on a Circumplex.

21. The computer readable medium of el aim 20, wherein the Circumplex includes a plurality of regions, and each of the plurality of jobs is categorized and mapped into one of the plurality of regions.

22. The computer readable medium of claim 20, wherein the energy level is plotted along the Y axis of the Circumplex and the valence level is plotted along the X axis of the Circumplex.

23. A system for evaluating a plurality of candidates from a plurality of audio responses, comprising:
a storage system; and
a processor programmed to:
extract and isolate a set of relevant emotional features, an energy level and a valence level from an audio clip of a plurality of raw emotional features; and
plotting the set of relevant emotional features, the energy level and the valence level over a categorized plurality of jobs.
